(19) United States
(12) Patent Application Publication
(10) Pub. No.: US 2014/0152454 A1
(43) Pub. Date: Jun. 5, 2014

(54) PORTABLE LONG-DISTANCE S.O.S. SIGNALING DEVICE

(71) Applicant: Lawrence E. Rabin, Pointe-Claire (CA)

(72) Inventor: Lawrence E. Rabin, Pointe-Claire (CA)

(21) Appl. No.: 14/236,781

(22) PCT Filed: Aug. 16, 2012
(86) PCT No.: PCT/IB12/02066

§ 371 Date: Feb. 3, 2014

Related U.S. Application Data
(60) Provisional application No. 61/524,716, filed on Aug. 17, 2011.

(51) Int. Cl. G08B 5/00

(52) U.S. Cl. CPC G08B 5/002
USPC 340/815.45

(57) ABSTRACT

A portable distress light signal device generates a visual S.O.S. distress signal indication visible from a significant distance away. Indicia including the letters “SOS” are disposed on either side of the device. A first set of light emitting diodes (LEDs) are disposed on both sides of the unit, each positioned within the interior of the region defined by each letter of the “SOS” indicia. A second set of LEDs, preferably of substantial power and luminosity, is likewise disposed on both sides of the unit, within the interior of the “O” portion of the “SOS” indicia. A power cord and power plug couples the unit to a source of electrical power, such as the cigarette lighter socket or 12-Volt accessory socket of an automobile or other vehicle. Powerful permanent magnets are preferably disposed about at least the bottom and right side edges of the housing, permitting the driver of an automobile to rapidly secure the unit to a ferromagnetic surface of the vehicle, such as the driver-side door or roof, in both cases with the SOS indicia oriented in horizontal orientation for easy recognition by passersby. Hazard warning stripes are disposed about the front and back sides of the housing for further enhanced visibility. Upon the application of power to the unit, an internal microcontroller repeatedly switches power to both the first and second sets of LEDs on and off causing them to pulse in a repeated sequence that corresponds to the S.O.S. signal in international Morse code.

### CROSS-REFERENCE TO RELATED APPLICATION

This application claims the benefit of U.S. Provisional Patent Application No. 61/524,716, filed Aug. 17, 2011, the entirety of which is hereby incorporated by reference.

### BACKGROUND OF THE INVENTION

1. Field of the Invention

The present invention relates, in general, to signaling devices and, more particularly, to a portable distress light signal device.

2. General Background of the Invention

Emergency signaling devices, such as those used in a roadside emergency, typically consist of the either emergency flares, or stand-alone roadside triangles, both of which may be placed on the road, along the oncoming path of traffic towards the vehicle. The deployment of these types of signaling devices typically require that the driver exit the disabled vehicle. Moreover, these conventional signaling devices are typically only visible for a short distance away from the disabled vehicle, and the illumination of flares typically lasts for only a relatively short amount of time. The present invention is operable without a driver having to exit a disabled vehicle and, moreover, may be visible from a distance of over eight kilometers in optimal conditions.

### BRIEF SUMMARY OF THE INVENTION

The present invention comprises a portable distress light signal device. The device generates a visual S.O.S. distress signal visible from as far as 8.4 kilometers at night and under ideal visibility conditions.

In a preferred embodiment, the housing for the device is made of a high quality polycarbonate. Other transparent materials may alternatively be used. The device in its casing is small enough to fit into most automobile glove compartments or other convenient storage areas. When used in an automobile, the unit is powered by a 12 Volt vehicle battery, and connected to this battery by being plugged into the cigarette lighter socket or conventional accessory power socket within the vehicle's interior. Even if the car, boat or snowmobile battery won't start the vehicle, there is usually plenty of energy to operate the S.O.S. light device. It can also be powered by a 12 Volt portable battery or by being plugged into a wall plug with a 12 Volt adaptor. The device emits high energy light beams which alert rescuers in three ways. First, as mentioned the light signal can be visible as far away as 8.4 kilometers as the device preferably generates approximately 150 lumens of light energy. Second, the light emitting diodes (LEDs) are arrayed in the letters S.O.S., the internationally recognized distress signal. Third, the lights flash intermittently, three pulses of the same duration, followed by three more of longer duration followed by the same three shorter pulses; this conveys the letters S.O.S. in international Morse Code (. . . _ _ _ . . .). The device has the S.O.S. array of lights on both sides of the device.

The invention can also function in and be adopted for non-motor environments. It can function as a visual distress signal in the home when placed in a window facing outside the house onto the street, yard, courtyard, or other venue. Stores and other commercial establishments facing a public thoroughfare can place units in their windows, which could be activated by an employee by remote control to attract attention in an emergency situation such as a robbery. Homeowners may likewise use the units in a similar manner. In another embodiment, portable units with batteries contained within the housing may be carried by those travelling off the beaten path, such as extreme skiers, mountaineers, hikers and so on.

One purpose of this invention is to reduce fatalities, injuries and property damage by alerting other drivers on the road that there is a disabled car in their path, and thereby avoid motor vehicle collisions. Another purpose is to attract potential rescuers who can see the light and the S.O.S. signal and S.O.S. lettering from a great distance on land, water, snow and air.

Ease of use is a principal benefit of the invention. An occupant of a disabled vehicle can remove the distress signal unit from a zippered pouch, unwind the approximately 3 meter (approximately 10 foot) long power cord, insert the power plug into the 12 volt “lighter” socket or power source, and thereby activate the powerful two-way S.O.S. light signal.

In its preferred embodiment, the unit includes integrated powerful magnets in its base and on at least one side. The vehicle occupant can easily affix the unit to the vehicle's metal roof by placing the base of the unit on the metal roof or to the metal door by placing the magnetized side of the unit against the door. In both cases, the letters S.O.S. will be correctly aligned for reading left to right and easily visible to other vehicles, as well as to pedestrians and cyclists. The S.O.S. message will convey distress information more quickly than other visual distress alert devices such as flares. Unlike flares, the device does not become inoperative after one use. Flashing hazard lights and road flares are also not bright enough and are positioned low to the ground, causing their visible range to be limited. The S.O.S. device of the present invention is much brighter in intensity than flares or bright headlights.

In a preferred embodiment, a rigid polycarbonate casing is provided and is extremely durable and strong, as well as being substantially waterproof and transparent. The unit can be dropped onto an asphalt roadway or other hard surface from a significant height without breakage. Observers can see the light signals by the naked eye 8.4 km from source, in ideal conditions at night. During bright sunlight, the distance is reduced due to heat waves and ambient light by about one third. The S.O.S. LED letters in the preferred embodiment have an intensity enabling them to be collectively read up to 225 feet away. Compared to regular road flares these LED's in the device are much brighter. Moreover, the flames of the flares may typically last only 20 minutes or so, while the battery power available even in a disabled vehicle may be sufficient to operate the unit for a far more extended period of time.

In a preferred embodiment, amber and similar colors are employed as the color of the LED lights, as this range of colors are commonly used in safety devices, and are thus commonly associated with emergencies by the public. The use of amber light can be understood and differentiated from street lights, flashing stop lights, antenna lights, house lights, and channel markers. Other colors may alternatively be used. In the rare circumstance that the unit may be placed in a manner where it faces directly into bright sunlight, the operator may fit an optional, auxiliary, thin anti-glare filter over the transparent faces of the device. A home alarm-type battery may optionally be used to power the device in vehicles without power outlets.

The unit houses an internal printed circuit board having a controlling computer, or microcontroller, as well as a power supply module. This printed circuit card is preferably dual sided, and may also function as the backing for the letters S.O.S. on either of its sides. Reflective material, such as silver foil, tape or silver covered paper or fabric may be applied to the printed circuit board backing behind the letters on each side and will accordingly function to reflect light in a mirrored effect, similar to when an individual in distress uses a mirror in a lashing manner to signal a rescue aircraft. This reflective material may also be applied to one or more of the four edges of the device. This feature is important if battery power is depleted or otherwise unavailable.

In a preferred embodiment, on at least one side of the transparent housing, the letters S.O.S., visible on the circuit card, is also disposed in a raised and transparent manner on the outer surface of the housing. Light shining through these elevated letters in the housing will thus make the three SOS letters even more visible from a distance. This effect may be enhanced by darkening or making opaque or translucent the remaining transparent material of the housing, in order to further highlight the raised letter portion.

In an alternative embodiment, a sound producing element may be provided and is activated by the device to broadcast the signal S.O.S. in Morse Code by the use of sound units of different lengths. The sound signal could be used concurrently with the visible light signal or in some instances separately, for example, to conserve battery power. A steady or periodic alarm tone may alternatively be employed.

In an embodiment of the present invention, the unit's housing includes internal channels in which the power plug and power cord may be stored. When these are removed from the channels for use, the power plug channel becomes a handle aperture, making it easier for the operator to place the device in position on the vehicle roof, door or elsewhere. Another channel may be be inserted into the casing alongside this channel to enable the power cord to be wound around the housing when the device is being stored.

### BRIEF DESCRIPTION OF THE SEVERAL VIEWS OF THE DRAWINGS

FIG. 1 is an elevated, simplified front perspective view of a first embodiment of the present portable long distance S.O.S. signaling device;

FIG. 2A is an elevated, simplified front view of a second embodiment of the present portable long distance S.O.S. signaling device;

FIG. 2B is an elevated, simplified left side view of the second embodiment of the present portable long distance S.O.S. signaling device;

FIG. 3 is an elevated, rear perspective view of the second embodiment of the signaling device of FIGS. 2A and 2B, shown attached to the left door of an automobile;

FIG. 4 is an elevated front view of the signaling device of FIGS. 2A and 2B, shown attached to the roof of an automobile;

FIG. 5 is a schematic diagram of the display unit of the present signaling device;

FIG. 6 is a schematic diagram of the power supply unit of the present signaling device;

FIG. 7 is a schematic diagram of the control unit of the present signaling device; and

FIG. 8 is a top-level flowchart of the operation of the microcontroller of the present invention.

### DETAILED DESCRIPTION OF THE INVENTION

While the present invention is susceptible of embodiment in many different forms, there is shown in the drawings and will herein be described in detail, several specific embodiments, with the understanding that the present disclosure is intended as an exemplification of the principles of the present invention and is not intended to limit the invention to the embodiments illustrated. Within the various illustrated embodiments, common reference numerals have been assigned to similar or analogous elements and components.

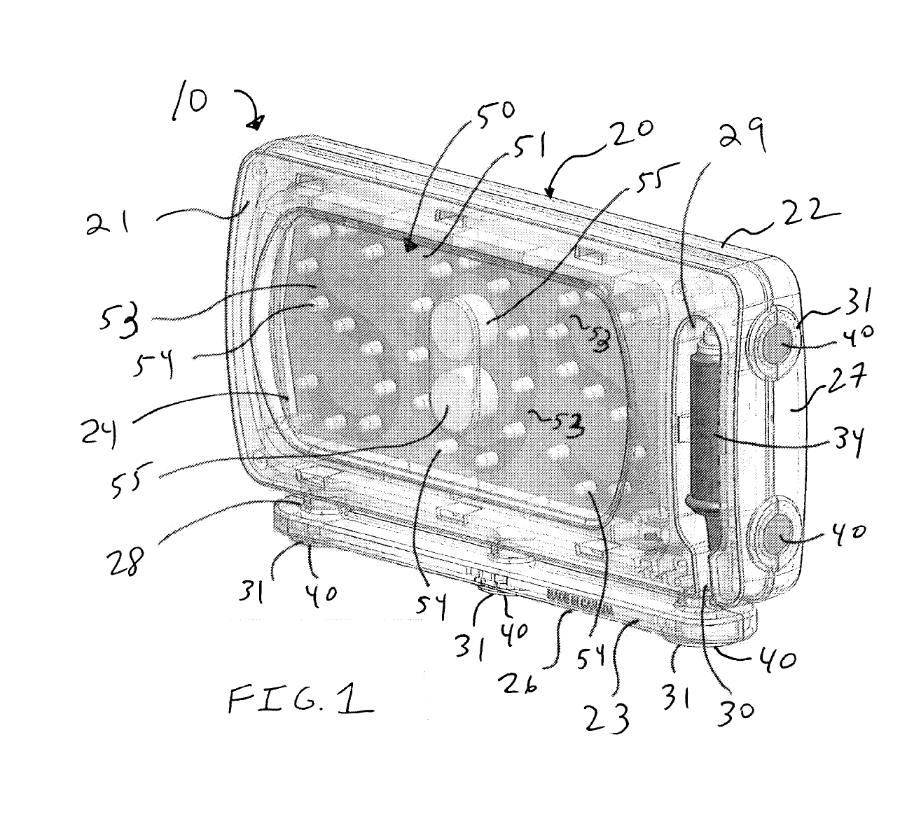

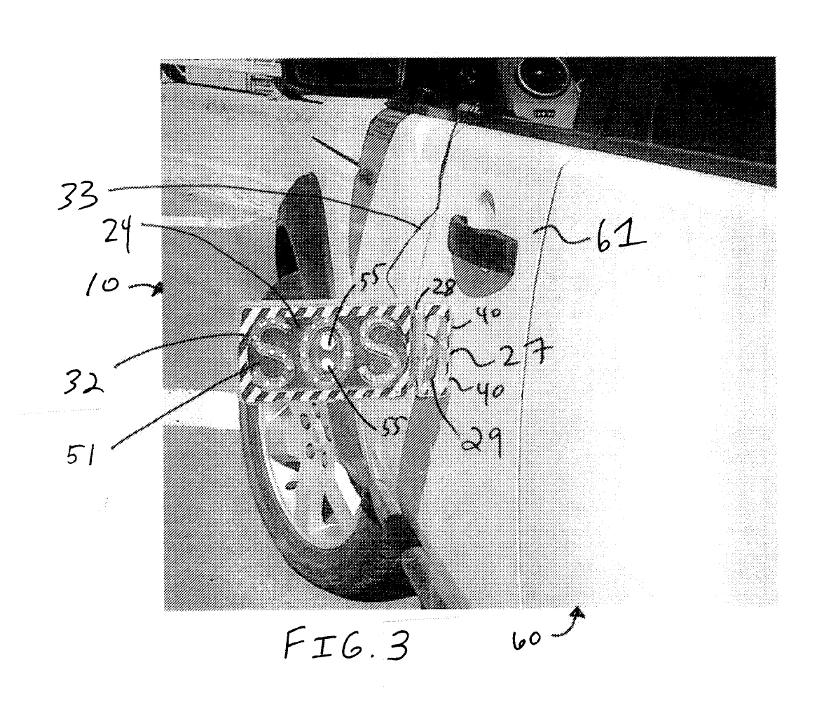

A first embodiment of the present portable long distance S.O.S. signaling device 10 is shown in FIG. 1 as comprising housing 20, preferably constructed of a sturdy polycarbonate material and having front housing portion 21 and rear housing portion 22, which collectively form the overall housing. Housing 20 further includes base region 23, front lens region 24, back lens region 25 (shown in FIG. 3), bottom side 26, right side 27, power plug receptacle 29 communicating through channel 30 with cord reel region 28, and a plurality of magnet receptacles 31. Specifically, base region 23 includes three magnet receptacles 31 disposed on bottom side 26, spaced substantially equidistantly apart along the length of housing 20. Right side 27 includes two additional magnet receptacles, spaced proximate the top and bottom edges of housing 20. Each magnet receptacle 31 is substantially cylindrical in shape and securely retains a relatively powerful, substantially disc-shaped magnet 40, exposing a top outer surface of magnet 40 for greater adhesion to a metallic surface.

Power plug receptacle 29 is configured to securely yet releasably store and retain power plug 34 which, in a preferred embodiment, is a 12-volt power connector for use with conventional vehicle 12-volt accessory outlets, originally developed for use in conjunction with automotive cigarette lighters. Such 12-volt accessory outlets are now commonly found on such vehicles as automobiles, trucks, boats and other watercraft, and general aviation aircraft. When power plug 34 is removed from power plug receptacle 29, power plug receptacle 29 becomes a handle aperture extending through housing 20, thus creating a convenient carrying handle for the overall unit proximate right side 27 of housing 20.

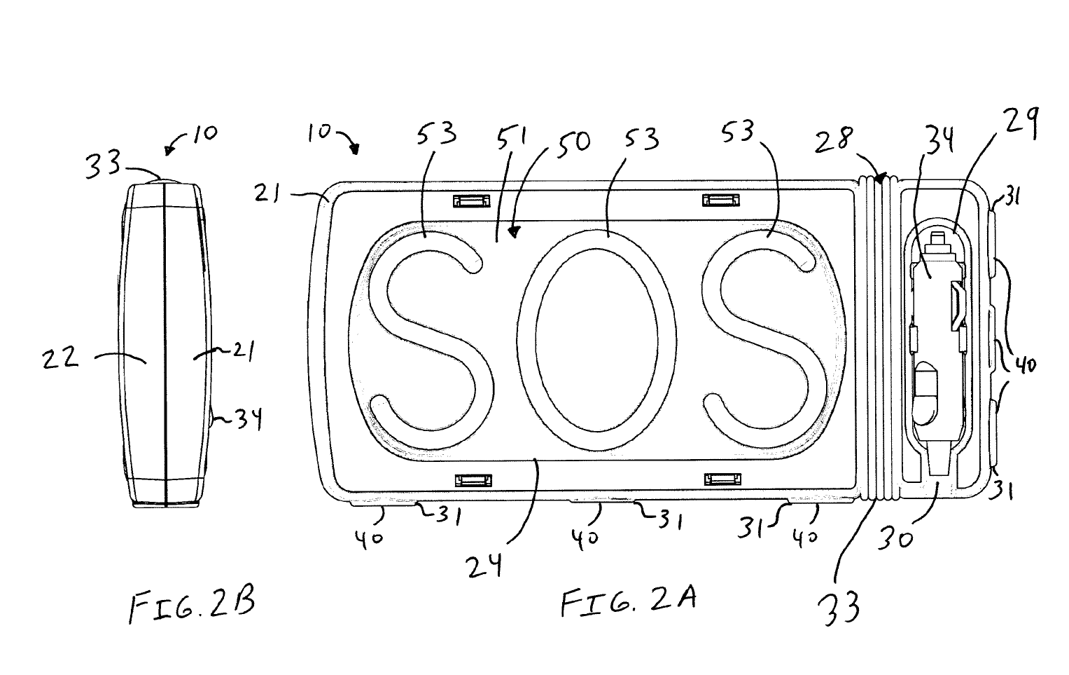

Power cord 33 (best seen in FIGS. 2A, 3 and 4) is preferably approximately three meters in length and electrically couples power plug 34, at one end, to the electronic circuitry housed within the interior of housing 20, thus powering the unit when power plug 34 is inserted within an appropriate cigarette lighter socket or 12-volt accessory outlet. Referring to FIG. 1, cord reel region 28 permits the majority of power cord 33 to be wound about base region 23 of housing 20, with power plug being inserted into power plug receptacle 29, thus enabling the overall unit to be stored compactly within the glove compartment or other storage region of a vehicle when the unit is not in use.

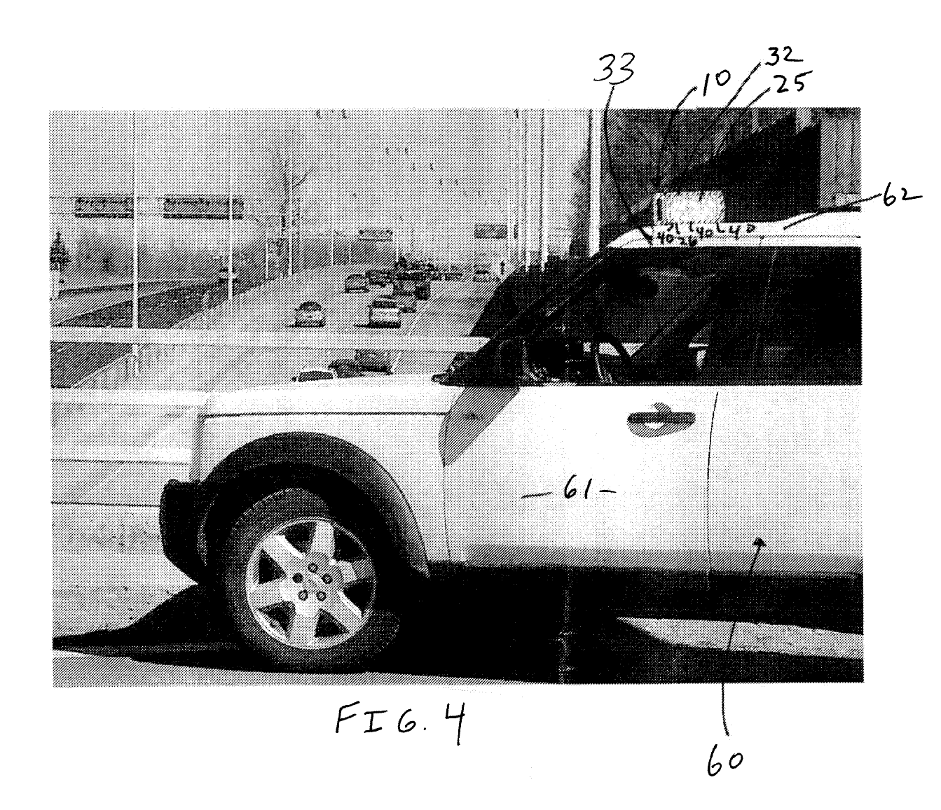

Display unit 50 preferably comprises a dual-sided printed circuit board and is carried within the interior of housing 20, with front side 51 of display unit 50 being visible through front lens region 24 of housing 20, and back side 52 of display unit 50 being visible through back lens region 25 of housing 20. As shown in FIGS. 3 and 4, for enhanced visibility, hazard warning stripes 32, in the conventional black and yellow striped colors, are preferably disposed on the front and back surfaces of housing 20, about the circumference of front lens region 24 and back lens region 25, as well as about the circumference of power plug receptacle 29.

A second embodiment of present portable long distance S.O.S. signaling device 10 is shown in FIGS. 2A, 2B, 3 and 4 (with LEDs 54 and 55 of display unit 50 being omitted in FIGS. 2A and 2B for clarity). In this embodiment, cord reel region 28 is disposed vertically, between power plug receptacle 29 and lens regions 24 and 25 of housing 20, rather than horizontally, along base region 23 of housing 20, as in the embodiment of FIG. 1. This, in turn, permits power cord 33 to be wound about cord reel region 28 in a vertical orientation, as opposed to a horizontal orientation, as in the embodiment of FIG. 1.

As shown in FIG. 3, in the event of a vehicle malfunction or other emergency situation, a driver of automobile 60 quickly and easily activate and deploy portable long distance S.O.S. signaling device 10 without leaving the safety of the vehicle's interior. In particular, once the unit 10 is retrieved from the glove compartment or other place of storage, power plug 34 is removed from power plug receptacle 29, and power cord 33 is unwound from about cord reel region 28 of housing 20. Power plug 34 is inserted into an appropriate 12-volt accessory outlet within the interior of automobile 60, powering the unit. Next, the window of automobile 60 is lowered, if necessary, and signaling device 10 is placed with right side 27 of housing 20 adjacent door 61 of automobile 60. This causes magnets 40 associated with right side 27 of housing 20 to be placed in close proximity to the outer surface of door 61. As door 61 is typically constructed of a substantially ferromagnetic material, this, in turn, causes housing 20 to releasably adhere to door 61, placing the overall unit in a position of high visibility to passersby, with the SOS letter oriented horizontal for easy reading by those outside of the vehicle.

As shown in FIG. 4, in the event of a vehicle malfunction or other emergency situation, a driver of automobile 60 may alternatively quickly and easily deploy portable long distance S.O.S. signaling device 10 without leaving the safety of the vehicle's interior by placing signaling device 10 with bottom side 26 of housing 20 atop roof 62 of automobile 60. This causes magnets 40 associated with bottom side 26 of housing 20 to be placed in close proximity to roof 62. As roof 62 is likewise typically constructed of a substantially ferromagnetic material, this, in turn, causes housing 20 to releasably adhere to roof 62, again placing the overall unit in a position of high visibility to passersby, oriented horizontal for rapid reading and recognition of the SOS signal.

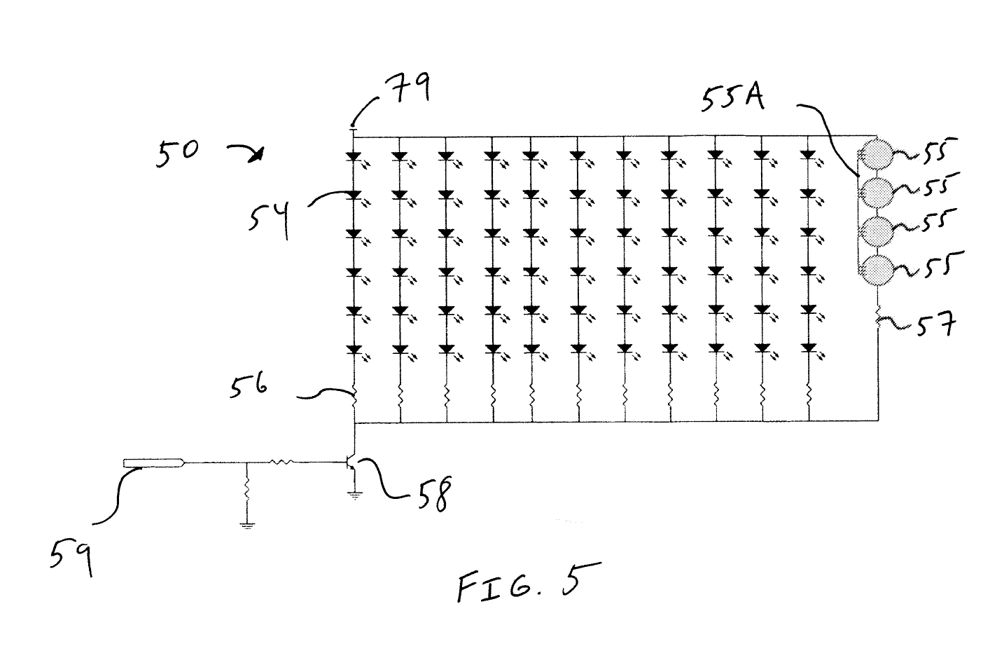

The electrical circuitry of the present portable long distance S.O.S. signaling device 10 is shown in FIGS. 5-7 as comprising display unit 50, power supply 70, microcontroller 90, and associated support circuitry. All of the circuitry may be mounted to a single, dual-sided printed circuit card. Alternatively, multiple printed circuit cards may be employed, with cabling or harnesses being employed to transfer both power and data signals from card to card.

Referring to FIG. 5, display unit 50 comprises sixty-six light emitting diodes (LEDs) 54, each associated with an individual letter component of display indicia 53 (as best seen in FIG. 1). Specifically, each side 51, 52 of display unit 50 includes three items of indicia 53 (the letters S, O, and S), and eleven LEDs 54 are disposed substantially equidistantly along and within the boundaries of each indicia 53, for a total of sixty-six LEDs 54. This indicia may be printed upon or superimposed adjacent each side of the printed circuit card carrying the circuitry of FIGS. 5-7. As shown in FIG. 5, LEDs 54 are electrically arranged in series in eleven groups of six LEDs, with each group of six having an associated current limiting resistor 56. Each LED 54 may comprise a LLR5VYAC053GA type LED, manufactured by Para Light Electronics Co. Ltd. Display unit 50 further comprises four high intensity LEDs 55, arranged in series and having an associated current limiting resistor 57. Each high intensity LED 55 may comprise a high power LED such as the 350 milliamp variety of the EP501 350 MA series, EP501WYL021WPT LED, manufactured by Para Light Electronics Co. Ltd. Even higher intensity LEDs, such as the 700 milliamp variety of LED manufactured by Para Light Electronics Co. Ltd., may alternatively be used. As a result of the use of such high intensity LEDs, the light emitted by the unit may be visible from as far as 8.4 kilometers away from the unit under optimal conditions. Moreover, in a typical automobile, even if insufficient cranking power is remaining in the vehicle's battery to start the engine, sufficient power will likely still be available to operate the present unit 10 for an extended period of time. Indeed, a “dead” car battery, insufficient to start an automobile, may still have as much as a six ampere battery reserve, which, in turn, may be capable of operating the present unit 10 for up to forty-eight consecutive hours.

As best seen in FIG. 1, each side 51, 52 of display unit 50 includes two high intensity LEDs 55, aligned vertically and surrounded by the “O” indicia 53. Inasmuch as high intensity LEDs 55 require a significant amount of power, and accordingly generate a significant amount of heat upon illumination, each high intensity LED 55 is preferably coupled to a common heat sink 55A to assist in dissipating the heat generated by operation of each high intensity LED 55. Common power for both LEDs 54 and high intensity LEDs 55 is received from power supply 70 and comprises the LED power signal Vled 79. On/off control for LEDs 54 and high intensity LEDs 55 is governed by a single digital logic flash control signal 59, received from microcontroller 90. Power switching transistor 58, controlled by flash control signal 59, effectively switches power to LEDs 54 and 55 on and off, and may comprise a bipolar NPN transistor such as a conventional FMM618 type power switching transistor.

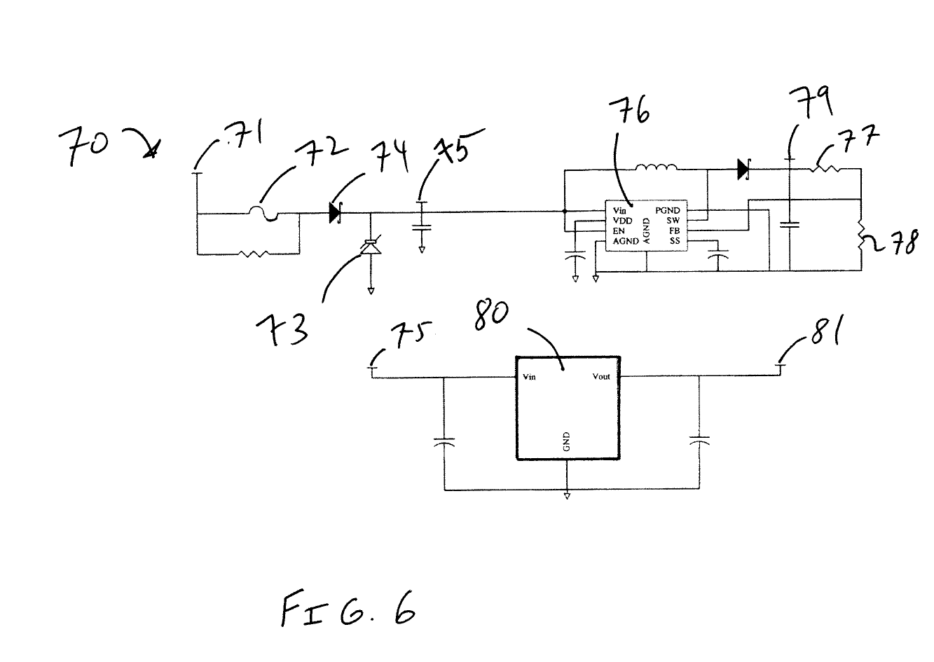

Referring to FIG. 6, power supply 70 is shown as comprising direct current (DC) input power 71 (coupled to and received via power cord 33 and power plug 34), fuse 72, transient voltage suppressor 73, and Schottky barrier rectifier 74, yielding an input voltage signal, Vin 75, having a nominal value of approximately twelve volts DC. Boost switching regulator 76, which may comprise an MIC2601YML integrated circuit manufactured by Micrel Inc., in combination with precision resistors 77 and 78, collectively furnish LED power Vled 79. In a preferred embodiment, values of resistors 77 and 79 are selected to furnish a Vled power 79 having a value of approximately seventeen volts DC. Voltage regulator 80, which may comprise an LD2915 voltage regulator manufactured by ST Microelectronics, provides a regulated digital logic power signal, Vlogic 81, derived from input voltage signal Vin 75 and having a nominal value of approximately five volts DC.

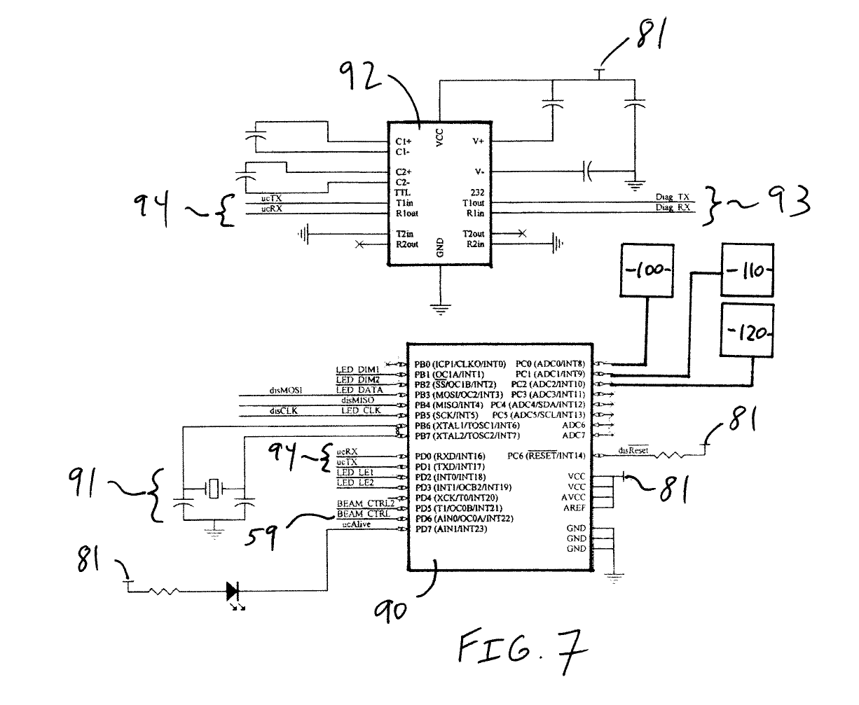

Referring to FIG. 7, the flashing of LEDs 55 and 55 is controlled by microcontroller 90, which outputs logic high and logic low signals via digital logic flash control signal 59, output from a data port of microcontroller 90, which may comprise an ATmega48-type microcontroller, manufactured by Atmel Corporation. Microcontroller 90 preferably includes an 8-bit microprocessor with on-chip program and non-volatile data memory in the form of an electrically erasable programmable read-only memory (EEPROM), as well as on-chip volatile data memory in the form of random access memory (RAM). Vlogic signal 81, received from power supply 70, powers microcontroller 90 and its related support circuitry. Time base 91, comprising a crystal oscillator and two associated capacitors, provides the external clock input signals that are coupled to designated clock input pins of microcontroller 90. Serial data transceiver 92, which may comprise a MAX232 transceiver manufactured by Maxim Integrated Products, is coupled to serial data port 94 of microcontroller 90 (comprising a serial data input pin and a serial data output pin), and converts serial data to/from microcontroller 90 to conventional RS-232 voltage levels at external serial data port 93. External serial data port 93 permits the EEPROM within microcontroller 90 to be programmed from an external source following manufacture of portable long distance S.O.S. signaling device 10. In particular, serial data port 93 may be cabled to the serial port of an external personal computer or the serial port of an external gang programmer (for programming multiple units 10 simultaneously) in order to download executable firmware instructions and associated data from the external source to microcontroller 90, thus programming the EEPROM within microcontroller 90.

With continuing reference to FIG. 7, additional data ports of microcontroller 90 may additionally be coupled to several optional components, including GPS receiver module 100, position transmitter module 110, and remote control receiver module 120. Optional GPS receiver module 100, when present, may comprise a single chip multi-GNSS receiver, such as the UBX-G7020 GPS receiver manufactured by u-blox AG, together with a suitable antenna, such as one manufactured by Antenova Ltd. GPS receiver module continuously identifies the current location of portable long distance S.O.S. signaling device 10 via the simultaneous receipt of positioning information from three or more GPS satellites, calculates the current position of unit 10 to within an accuracy of several meters, and transmits the location to an input port of microcontroller 90. Optional position transmitter module 110, when present, broadcasts data identifying the current position of portable long distance S.O.S. signaling device 10 over a radio frequency. Optional position transmitter module 110 may comprise a radio frequency transmitter, such as those manufactured by u-blox AG, together with an associated broadcast antenna, transmitting to cellular or other terrestrial receivers using an existing communication standard, such as any of the GSM, CDMA, 3G, 4G, LTE, or WiMAX communication standards. Alternatively, transmitter module 110 may broadcast directly to an orbital satellite, such as the global COSPAS SARSAT search and rescue satellite communication system using the 406 MHz frequency. In either case, when both optional GPS receiver module 100 and optional position transmitter module 110 are present, firmware programmed into microcontroller 90 causes microcontroller 90 to continuously monitor the input port associated with GPS receiver module 100 and, whenever GPS coordinates are received, to then retransmit those coordinates using a suitable communications protocol out of the data port coupled to position transmitter module 110, which, in turn, broadcasts the current position of the unit via a monitored emergency frequency on a cellular network, other terrestrial network, or network of orbital satellites.

Optional remote receiver 120, when present, receives predetermined control commands in the form of RF remote control radio signals from a handheld, battery-operated remote control unit, and forwards data indicative of the received signals to microcontroller 90. This data, each having an associated button on the remote control unit and being generated by the remote control unit upon the activation by the user of the associated button, may be employed to instruct microcontroller to power on and off entirely (apart from standby power used for monitoring remote control signals emanating from remote receiver 120), to enable/disable the operation of GPS receiver module 100 and position transmitter module 110, and to enable/disable the operation of an optional distress signal audio speaker.

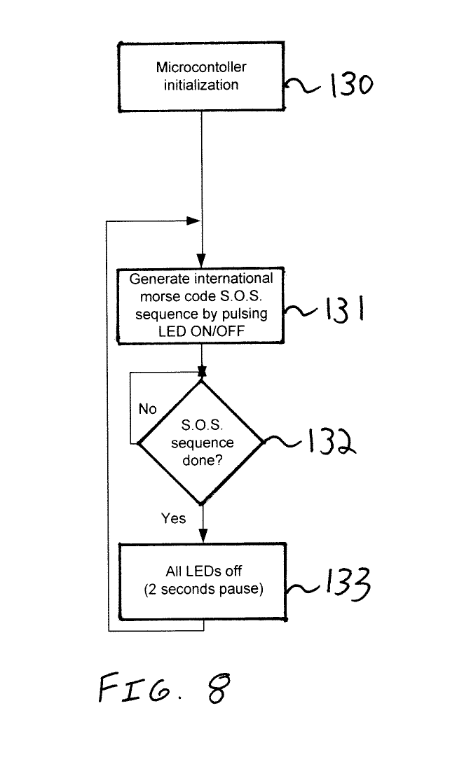

Referring to FIG. 8, the operation of the firmware programmed into microcontroller 90 is shown. In step 130, upon the initial application of power to the unit, such as when power plug 34 is initially inserted into a suitable 12-volt accessory outlet of an automobile or other vehicle, microcontroller performs general power-on initialization operations. Next, transition is taken to step 131, wherein microcontroller 90 commences the optical generation of the international Morse code S.O.S. signal, simultaneously pulsing each of LEDs 54 and 55 on and off via the modulation of flash control signal 59 output to display unit 50. In particular, the letter S, represented by three dots, or short bursts of light, is generated by three short digital logic pulses being output from microcontroller 90 via flash control signal 59. The letter O, comprising three dashes, or longer bursts of light, is generated by three longer pulses being output from microcontroller 90. A second letter S is then output in the same manner, completing the overall optical SOS sequence. In general, the duration of each dash is approximately three times the duration of each dot, and each dot or dash is followed by a brief period “off” interval of the LEDs. In step 132, a test is performed to determine if a single overall SOS transmission sequence has been completed. If not, this step 132 is repeated, and transmission of the current SOS signal continues. Otherwise, transition is taken to step 130, where each of LEDs 54 and 55 are turned off for an extended period of approximately 2 seconds. Transition is then taken back to step 131, where another SOS visual sequence is then generated. In this manner, the unit will continue to visually output pulsed SOS signals for so long as adequate external power is supplied to the unit.

An optional high decibel speaker, such as a piezoelectric type device, may optionally be driven by an output port of microcontroller 90. Microcontroller 90 may be programmed to continuously output an alarm signal to the speaker simultaneously with the strobed operation of the LEDs. To conserve power, the optional remote control may include an audio on/off button, permitting the operator to instruct microcontroller 90 to disable the speaker when desired. The speaker is preferably carried within housing 20 and emits sound through louvers or other openings through the surface of housing 20.

While the embodiments described above are suitable for use with any 12-volt accessory outlet, such as those commonly provided by automobiles, trucks, boats, snowmobiles, motorcycles, and general aviation aircraft, other sources of power may alternatively be used. Moreover, power cord 33 and power plug 34 may alternatively be replaced with, or augmented by, an internal source of electrical power, such as either disposable or rechargeable batteries, solar cells, or a hand-cranked or other power generator, enabling operation of the unit from remote locations, where external power is unavailable, and enabling continued operation of the unit once an automobile battery or other source of external power is exhausted.

Many modifications and variations of the present invention are possible in light of the above teachings. It is therefore to be understood that within the scope of the appended claims, the invention may be practiced other than as specifically described. Various modifications, changes and variations may be made in the arrangement, operation and details of construction of the invention disclosed herein without departing from the spirit and scope of the invention. The present disclosure is intended to exemplify and not limit the invention.

What is claimed is:

1. An emergency signaling device, comprising:
a housing having an interior and an exterior;
indicia, visible from the exterior of the housing, and comprising at least one instance of the letters S, O and S;
at least one light source, visible from the exterior of the housing; and
a controller coupled to the at least one light source and causing the at least one light source to pulse in a manner corresponding to a visual indication of the letters S, O, and S in international Morse code.

2. The invention according to claim 1, wherein the indicia comprises two instances of the letters S, O, and S, each instance being visible from an opposing side of the housing.

3. The invention according to claim 1, wherein the at least one light source comprises a plurality of light sources simultaneously pulsed by the controller in a manner corresponding to a visual indication of the letters S, O, and S in international Morse code, and wherein each of the letters S, O, and S includes at least one of the simultaneously pulsed light sources disposed within an outline of the respective letter.

4. The invention according to claim 1, wherein the at least one light source comprises a high intensity light emitting diode, pulsed by the controller in a manner corresponding to a visual indication of the letters S, O, and S in international Morse code.

5. The invention according to claim 4, wherein the at least one light source comprises two high intensity light emitting diodes, each disposed within an interior region of the letter O indicia and pulsed by the controller in a manner corresponding to a visual indication of the letters S, O, and S in international Morse code.

6. The invention according to claim 1, further comprising at least one magnet.

7. The invention according to claim 6, wherein the at least one magnet comprises at least one magnet disposed proximate a bottom surface of the housing.

8. The invention according to claim 6, wherein the at least one magnet comprises at least one magnet disposed proximate a side of the housing.

9. The invention according to claim 6, wherein the at least one magnets comprises at least one magnet disposed proximate a bottom surface of the housing and at least one magnet disposed proximate a side surface of the housing.

10. The invention according to claim 1, wherein the housing further comprises a power plug receptacle.

11. The invention according to claim 10, wherein the power plug receptacle functions as a handle aperture when a power plug is removed from the power plug receptacle.

12. The invention according to claim 1, wherein the housing further includes a cord reel region.

13. The invention according to claim 1, wherein the emergency signaling device is powered by an external power supply.

14. The invention according to claim 1, wherein the emergency signaling device is powered by an internal power supply.

15. The invention according to claim 1, further comprising a GPS receiver.

16. The invention according to claim 1, further comprising a radio transmitter broadcasting a current position of the emergency signaling device.

17. The invention according to claim 1, further comprising a remote control receiver receiving control commands from a wireless remote control unit.

18. The invention according to claim 1, wherein at least a portion of the housing comprises a substantially transparent material.

19. The invention according to claim 1, further comprising an anti-glare filter attachable to at least a portion of the housing.

20. The invention according to claim 1, further comprising hazard warning stripes visible from the exterior of the housing.
